(19) United States
(12) Patent Application Publication
(10) Pub. No.: US 2026/0061614 A1
(43) Pub. Date: Mar. 5, 2026

(54) INDUSTRIAL SYSTEMS AND METHODS FOR UPDATING A SAFETY PROGRAM

(71) Applicant: SICK AG, Waldkirch (DE)

(72) Inventors: Pascal LIEGIBEL, Waldkirch (DE); Thomas NEUMANN, Schallstad (DE); Christoph HOFMANN, Waldkirch (DE)

(21) Appl. No.: 19/312,130

(22) Filed: Aug. 27, 2025

(30) Foreign Application Priority Data
Aug. 28, 2024 (EP) 24196865.0

(51) Int. Cl. B25J 9/16; G06F 8/65; G06F 11/10

(52) U.S. Cl. CPC B25J 9/1674; B25J 9/1653; G06F 8/65; G06F 11/1004

(57) ABSTRACT

An industrial system comprises: a sensor and/or an actuator; a safety apparatus configured to execute a safety program for controlling the sensor and/or the actuator; and an update device configured: to obtain update information; to evaluate the update information; based on the evaluation, to determine whether the update information can be applied to the safety program; and, based on the determination, either to apply the update information to the safety program or to discard the update information.

The invention relates to industrial systems and methods for updating a safety program.

An industrial system, such as a production environment, for example a production cell, which can consist of a robot, a machine and safety devices, can be a type of automated production system that can be configured to perform a specific task safely and efficiently. The robot can be responsible for handling the workpiece and for transporting it between different machines and workstations. The machine can carry out the actual production process, for example welding, cutting or assembly. The safety devices can be configured (for example, by executing a safety program) such that they protect the workers from all hazards associated with the production process.

The manufacturing process can be protected by a program that is executed on a controller. This program can be called a safety program.

This program can be responsible for performing various safety operations, such as stopping the robot or the machine when a worker enters the work cell; or, for example, preventing the robot or the machine from starting until all safety apparatus are present and functioning properly; or, for example, limiting the speed and the range of motion of the robot or the machine to prevent collisions with workers or other objects; or, for example, monitoring the manufacturing process for irregularities or problems and shutting down the robot or the machine, if necessary.

In this respect, it may be necessary to update the safety program, for example, to provide a new functionality or to rectify errors in the safety program.

It is an object of the invention to enable an updating of the safety program without compromising the safety of the system that monitors the safety program.

The object is satisfied by an industrial system having the features of claim 1 and by a method for updating a safety program having the features of claim 14.

An industrial system according to the invention comprises: a sensor and/or an actuator; a safety apparatus configured to execute a safety program for controlling the sensor and/or the actuator; and an update device (which can also be referred to as an update agent) configured: to obtain update information; to evaluate the update information; to determine (based on the evaluation) whether the update information can be applied to the safety program (for example, without incurring a safety risk); and, based on the determination, either to apply the update information to the safety program (if it is determined that the update information can be applied to the safety program) or to discard the update information (if it is determined that the update information cannot be applied to the safety program).

In other words, before applying the update information to the safety program, it can be checked whether the update information can be applied to the safety program (for example, without thereby incurring a safety risk).

The existing hardware on which the safety program runs can be divided into nodes as computing nodes. In the nodes, there can in turn be one or more so-called pods as sub-nodes and therein the containers with the actual micro-services, for example logic units including the associated container runtime and thus all the libraries and dependencies required for the logic unit at runtime.

The application of the update information can include or be a use of updated pods.

The evaluation of the update information can comprise applying the update information to a second safety program. This can be called a sandbox method.

Here, the changes that result from the update information can first be checked in a second safety program that can be identical to the safety program. However, the second safety program cannot be used in a production environment so that no “real” safety risks can arise here.

The application of the update information to the safety program can include or be a use of the second safety program as the safety program. As can be seen, if the second safety program works properly even after applying the update information, the second safety program can be used as the safety program. Alternatively, the update information can be applied directly to the safety program after a test run has been performed with the second safety program.

The evaluation of the update information can include an automated acceptance test.

The evaluation of the update information can include or be a check whether all the parts of the safety program to be updated are covered by the update information. It can thus be ensured that the update is carried out completely.

The evaluation of the update information can include or be a check whether the update information does not contain a contradiction. It can thus be ensured that the update takes place consistently across the entire safety program.

The evaluation of the update information can include or be a check whether the update information does not contain different version numbers. Thus, a version mismatch can be avoided.

The evaluation of the update information can be based on a digital signature of artifacts that are described in the update information.

The evaluation of the update information can be based on a checksum.

The update device can further be configured to determine whether a safety system, which is monitored by the safety program, is in a predefined state, wherein the evaluation of the update information and/or the application of the update information to the safety program is only performed if it is determined that the safety system is in a predefined state. For example, the predefined state can be a pause state or a predefined safe state. It can thus be ensured that no safety risk arises during the update.

The update information can include or be information for an update of the safety program and/or a troubleshooting for the safety program and/or a new functionality for the safety program.

The actuator can comprise a robot or can be a robot and/or can comprise a machine or be a machine. The sensor can be configured to acquire measurement data with respect to a human in an environment of the actuator. For example, the sensor can provide data on whether the human operating, maintaining or inspecting the actuator is exposed to a potential danger from the actuator. For example, the actuator can be a robot and, if the sensor determines that the robot is moving towards the human, a safety warning can be issued.

The object of the invention is further satisfied by a method for updating a safety program. In this respect, the safety program is configured to be executed in a safety apparatus in order to control a sensor of an industrial system and/or an actuator of the industrial system. The method for updating a safety program comprises: obtaining update information; evaluating the update information; determining (based on the evaluation) whether the update information can be applied to the safety program (for example, without incurring a safety risk); and, based on the determination, either applying the update information to the safety program (if it is determined that the update information can be applied to the safety program) or discarding the update information (if it is determined that the update information cannot be applied to the safety program).

A computer readable storage medium can further be provided that comprises commands that, on the execution by a computer, cause it to carry out the method described herein.

Further advantageous embodiments of the method according to the invention result from the dependent claims, from the drawing, and from the description.

The invention will be described in the following with reference to embodiment examples and to the drawing. There are shown in schematic representations:

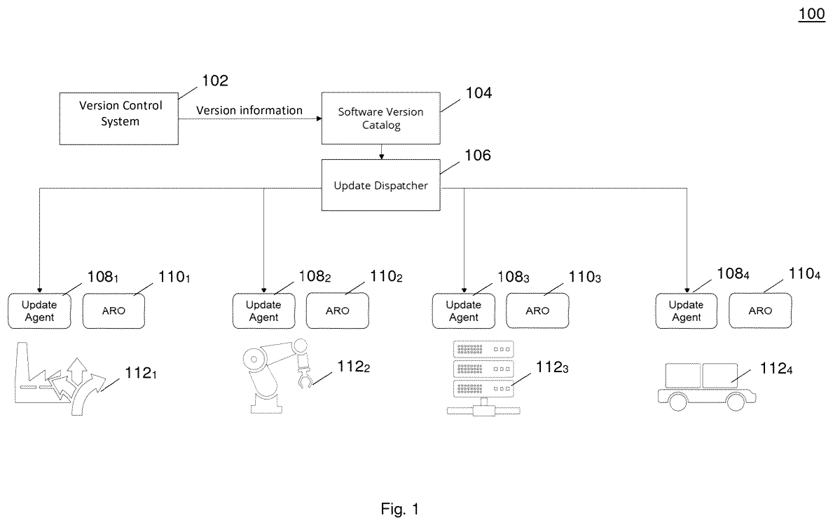

FIG. 1 a production environment according to an embodiment;

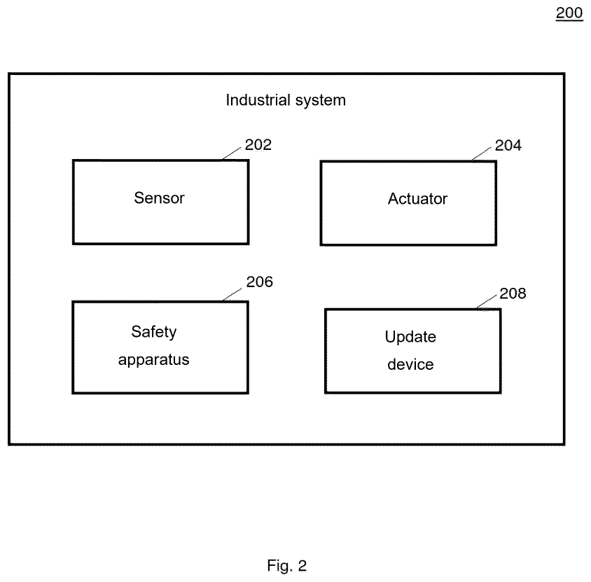

FIG. 2 an industrial system according to an embodiment; and

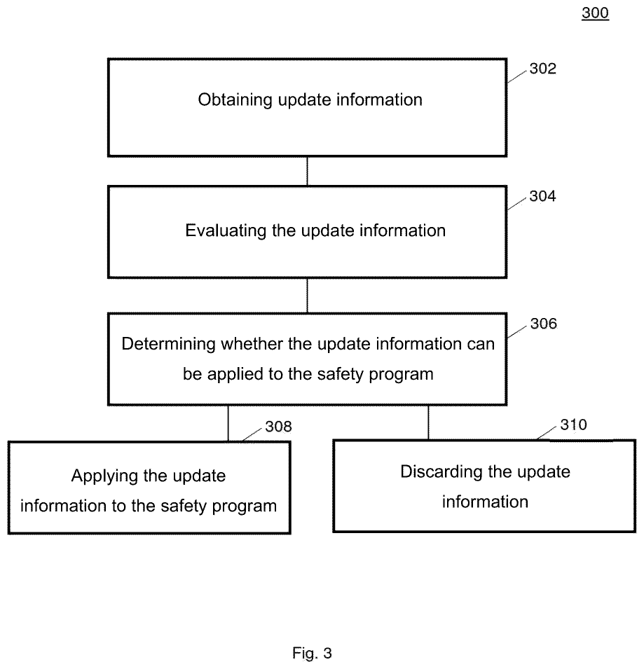

FIG. 3 a flowchart that illustrates a method for updating a safety program according to an embodiment.

In the following, the methods and apparatus according to the invention will be explained in an exemplary manner with reference to embodiment examples.

In one embodiment, a GitOps-based provision can be provided via a wireless network (which is also known as over-the-air deployment) of Kubernetes (for example, by secure container orchestration software such as described, for example, in European patent applications 24 176 635.1 and 24 176 655.9) in an IIoT (Industrial Internet of Things) context. For example, standards and a security-compliant rollout of security software for Kubernetes (for example, secure container orchestration software such as described, for example, in European patent applications 24 176 635.1 and 24 176 655.9) can be provided.

GitOps is a concept that manages infrastructures and applications via a declarative approach (i.e. an approach in which, for example, a desired software version is defined for the respective hardware) and controls them with Git, a widely used version control system in software development. The aim is to enable automated sequences, time savings and a better collaboration between teams. In this respect, the target state of a system can be described declaratively, changes can be made via pull requests, and the GitOps operator can ensure that these changes are taken over in the live infrastructure.

Kubernetes offers a plurality of mechanisms for updating deployments. One strategy is a rolling update that enables the gradual provision of new versions of applications while simultaneously maintaining the availability of the application.

A rolling update can take place as follows:
a. First, the configuration file of the deployment is updated to specify the desired new version of the application. This can take place by changing the image version or other configuration settings.
b. After the configuration file has been updated, Kubernetes gradually creates new pods that are based on the new configuration. These new pods are started gradually in order not to excessively overload the resources of the cluster.
c. While new pods are started, Kubernetes monitors the progress of the rolling update. It ensures that the defined criteria such as the maximum number of unavailable pods and the maximum number of additional pods are met.
d. After the new pods have been successfully started, Kubernetes checks whether they are working properly. Kubernetes monitors their health and, if necessary, performs automatic rollbacks when problems occur.
e. If the new pods are ready and working successfully, Kubernetes begins to gradually take the old pods out of operation. This takes place in order to gradually switch the application to the new version while simultaneously maintaining a continuous operation.
f. Once all the new pods have been started and the old pods have been taken out of operation, the rolling update is complete. The application now runs with the new version without any major downtimes or interruptions.

FIG. 1 shows a production environment 100 according to one embodiment with a version control system 102 (for example Git), a software version catalog 104 and an update dispatcher 106. Different machines or robots (for example mobile robots), servers or data centers 112₁, 112₂, 112₃, 112₄ are each monitored via an update agent 112₁, 112₂, 112₃, 112₄ and an automated resource orchestrator 110₁, 110₂, 110₃, 110₄.

The different recipients on the lower half of FIG. 1 symbolize the possible recipients of updates. These recipients of updates can be referred to as deployment targets. They can be, for example, devices, machines or data centers of clients. The deployment targets can be outside the direct area of influence of the company that provides the safety program. For example, Kubernetes can run on the deployment targets. A deployment target can also be referred to as a cluster.

The software version catalog (SVC) as well as the update dispatcher and the version control system can be run in a data center or completely in a cloud of any public cloud provider (for example, AWS, Azure, GCP, IBM, Alibaba Cloud). A hybrid solution with parts in the data center and other parts in the cloud can also be used.

In one embodiment, a combination of an ARO (Automated Resource Orchestrator as described, for example, in European patent application 24 176 635.1) and an update agent, such as described herein, is provided.

In one embodiment, an update dispatcher is provided. The update dispatcher can keep a record of the safety programs currently installed on the different target systems. For this purpose, the update dispatcher can recognize the current version status of the installed safety programs and, if necessary, their parameterization. The update dispatcher can know all the safety programs, as well as their versions, artifacts and dependencies, that are ready for installation on a target system and can store them in a software version catalog. The update dispatcher can continuously compare the catalog of the target systems with the software version catalog and can thus determine the safety programs and their versions that need to be installed on the individual target systems. The update dispatcher can transfer the safety programs to be installed to the target systems. The update dispatcher can have a role-based safety concept that only allows certain actions for certain persons.

The configuration of the update dispatcher can either be an in-house development or can be realized from an already existing tool established in cloud computing/software development.

For example, the following tools can be used individually or can also complement one another in parts (for example, ArgoCD could be used with a main focus on continuous delivery and Keptn could be used for monitoring a service level objective (SLO)):
ArgoCD (which has a CNCF (Cloud Native Computing Foundation) status of “graduated”) is a Kubernetes-native tool for executing workflows, managing clusters and “do GitOps right”.
“do GitOps right” is ArgoCD's slogan and refers to the adherence to “best practices”, which ArgoCD supports and enforces. These include, among others:
   Separation of the application source code and the application configuration;
   Provision of a clear audit log;
   Access to or management of a plurality of Git repositories with source code, but only one config repository for the provision;
   Allocation of access rights to the source code vs. access right to configurations.
Flux (which has a CNCF status of “graduated”) is an open and extensible solution for the continuous delivery of Kubernetes and is powered by the GitOps Toolkit.
Keptn (which has a CNCF status of “incubating”) is a cloud-native application lifecycle orchestration. Keptn can automate the SLO (Service Level Objective)-driven multi-stage delivery and provide the operation and remediation of applications.

In one embodiment, an update agent can be provided. The update agent itself is neither part of Kubernetes nor of any other third-party technologies. The update agent can perform the tasks described below in order to carry out an update process on the deployment-target side or to provide information about an update.

The update agent can transmit the current version status of the software programs installed on the target system to the update dispatcher. For the determination of the current version status of the software resources located on the target system (such as the safety program or Kubernetes information), the update agent can access two sources of information: the Kubernetes API server and the ARO.

The Kubernetes API server provides a REST programming interface to retrieve all the Kubernetes objects located in the cluster (deployments, replica sets, Daemon sets, . . . ). The current versions of container images or other objects can therefore be determined with reference to this interface and can be forwarded to an update dispatcher.

The ARO (as described, for example, in European patent application 24 176 635.1) contains safety-relevant configurations and can actively communicate them to the update agent via a common interface (for example, a REST (Representational State Transfer) interface or gRPC). The configuration information can be bundled by the update agent together with the object information of Kubernetes.

The update agent can check the consistency of the obtained software program distributions. This can include checking individual components. For example, it can be checked whether all the components of a safety program have been updated (for example on the basis of container image hashes or version numbers of the safety program). It can be checked whether the updates do not contradict one another (for example by means of a logical check in cooperation with the ARO (for example, a safety program has exactly one root node (such as described in European patent application 24 176 635.1, for example), or a safety program references a function that becomes obsolete after an update). It can be checked whether there is a version mismatch between individual components of a safety program or a version conflict between dependencies of a safety program (for example, by a check based on the update information provided by the update dispatcher).

One (or more) digital signature(s) of the artifacts and a checksum can be used to check the update process.

Even further mechanisms (for example, blockchain verification) can be used for parts of the safety subsystem (for example, ARO) since these components are very important for safety.

The update agent can inform the local safety engineer that a new version of a safety program is ready for installation.

Furthermore, the update agent can also take on the central function of “Reconciliation Sentinels”. The term “Reconciliation Sentinel” is an in-house designation. There is no designation or procedure in Kubernetes with this name. In this role, the update agent performs an automated acceptance test or commissioning test that is linked to the following criteria or that has corresponding characteristics/procedures, as described below.

The update agent can ensure that the system is in a safe state (which allows an update). If the update agent cannot determine a safe state, it can hold back the update. What this state looks like can be application-specific and can be part of the safety consideration within a safety development process. In the case of an autonomous mobile robot (AMR), for example, this state could be reached when the AMR is on a charging station. In this state, the sensors and actuators are available without having to interrupt an operation.

To carry out the acceptance test, the update agent can open a namespace that is encapsulated from the production system and that provides a software-side isolation of the software/Kubernetes resources (which can be referred to as a sandbox). The update agent can ensure the provision of the updated objects/containers in interaction with the ARO and can perform an application-specific acceptance test.

Since the machine (e.g. AMR) is then in a safe state and there is therefore no productive workload, access to all the sensors and actuators is possible during the test run so that an end-to-end test takes place without incurring a safety risk.

The update agent can announce the execution of the test run in the safety subsystem (as described, for example, in European patent applications 22 216 057.4, 24 176 635.1 and 24 176 655.9). In this way, the safety subsystem (for example via a system interrupter) can actively control outputs (e.g. OSSD; Output Signal Switching Device) or actuators, check them and pass the information on to the update agent. In this way, a cycle can be created in the test and the update agent can complete the update or repeat the test.

The system interrupter can also be referred to as a shutdown service and can be a central component of the safety infrastructure that would initiate an emergency stop. In this case, the system interrupter can recognize the test run and intercept or evaluate the signal to shut down in order to complete the acceptance test. Details on the system interrupter are also described in more detail in European patent application 22 216 057.4.

After a successful update and the acceptance, the machine can continue to work in normal operation.

The software versions catalog (SVC) can be a kind of metadatabase to which the following responsibilities are assigned: assigning version numbers to deployment artifacts; and/or representing safety programs including their dependencies.

Dependencies can here be other safety programs, required hardware or even external machines and/or a robot.

The necessary information can be provided to the SVC via a simple programming interface by external systems or actors (for example, product managers). The programming interface can be designed such that it supports the following operations: adding version artifact assignments; and/or querying assignments and dependencies; and/or deleting assignments; and/or marking assignments as obsolete.

The SVC does not offer an option of updating assignments in order to ensure consistency.

The SVC can be a database (for example, a relational or NoSQL database). The SVC can retrieve the required information partly in a self-event-driven manner via metadata of stored artifacts (for example, hashes for verification); on the other hand, the SVC can be partly dependent on the active input of data from actors. Actors can be both the people involved (for example, product managers or safety engineers) and automated mechanisms (for example, CI/CD pipeline, software bill of materials).

The SVC can execute an audit trail that logs changes in a traceable manner. The design of the audit trail can be variable and can range from a simple version control system such as Git to secured log files and a distributed blockchain.

The SVC can be implemented using a database from various manufacturers (MySQL, Oracle, Postgres, . . . ) and can take various forms (for example, relational or document-oriented), or a ratification tool such as Notary can be used to sign and verify any software artifacts.

The Notary Project (which has a CNCF status of “incubating”) can sign and verify artifacts, and this can support the security of the software delivery from deployment to deployment.

An exemplary sequence for distributing safety programs to different target systems can be as follows according to different embodiments:

Step 0: The software version catalog continuously receives information about safety programs that are ready for installation on a target system. This information can be transferred either manually or automatically from a build system to the software version catalog. The information stored in the software version catalog includes the version number, artifacts and dependencies of the installable software programs.

Step 1: The update dispatcher continuously receives information from the target systems about the installed safety programs.

Step 2: Either an actor releases a version of a safety program manually or the update dispatcher decides independently that a version of a safety program can be installed on target systems. The automatic release of software versions can in particular be used for the release of versions that do not contain any changed/extended functionality (e.g. bug fix).

Step 3: The update dispatcher continuously compares the software version catalog with the information about the safety programs on the target systems and determines the versions of a safety program to be installed on the individual target systems. For the determined safety program versions to the target systems, the update dispatcher transmits the artifacts and metadata to the target systems.

Step 4: After the update agent has received the distribution of a safety program version, it checks it for consistency and notifies the local safety engineer that a new safety program is ready for installation.

Step 5: The local safety engineer decides to install a new version of the safety program and releases it via the user interface.

Step 6: The already running version of the safety program is deactivated and deleted.

Step 7: The new version of the safety program is installed.

Step 8: The local safety engineer checks the installation of the safety program and its functionality.

Step 9: The local safety engineer activates the newly installed safety program and releases it.

With the methods and apparatus according to different embodiments, a rapid distribution of safety software updates and solutions can be provided. New possibilities for dynamic adjustments and agility in the safety domain can be provided.

With the methods and apparatus according to different embodiments, safety innovations can be brought to the clients at a similarly high speed as has long been the case in the traditional software and information technology industry.

In one embodiment, a rolling update mechanism can be used in which there is no downtime.

In one embodiment, a two-factor authentication is, for example, used (for example in step 5 described above) to implement the role-based safety concept (which only allows certain actions for certain persons).

In one embodiment, for example, a TAN (transaction number) procedure or pass keys is used to arm the new safety application (for example in step 9 described above).

It will be understood that although the above examples relate in part to Kubernetes, the methods and apparatus according to different embodiments can also be applied to other systems, in particular other systems for container management.

In the methods and apparatus according to different embodiments, the update agent can be deployed on the target system and can collect information there (for example, information about what hardware is present and/or what state is present). In this respect, a consistency check of obtained software can take place and an automated acceptance and commissioning test can then be performed. The update can first be applied in a sandbox and the commissioning test can be performed there (wherein the expectations are known). Updates can also add completely new functions, for example, to expand the capabilities of the sensors, and this can then result in different (or new) expectations.

With the methods and apparatus according to different embodiments, a distribution of the updates and thus better dynamics can be achieved. It is possible to carry out the tests without downtime during the production phase.

Coding guidelines for safety-relevant components can be taken into account. For example, the structure of the program code can be predefined, defensive programming can be used, unit tests or component tests can be carried out. It can further be checked whether a packet has also actually arrived on the target system (for example, by means of confirmation via a packet manager), which can be regarded as a preliminary stage to an acceptance test (which can be provided as a plug-in in the update agent). Application-specific tests can be carried out to check whether sensors and actuators are working.

FIG. 2 shows an industrial system 200 according to an embodiment. The industrial system 200 can include a sensor 202 and/or an actuator 204. The industrial system 200 can further include a safety apparatus 206 that can be configured to execute a safety program in order to control the sensor 202 and/or the actuator 204. The industrial system 200 can further include an update device 208 that can be configured: to obtain update information; to evaluate the update information; based on the evaluation, to determine whether the update information can be applied to the safety program; and, based on the determination, either to apply the update information to the safety program or to discard the update information.

FIG. 3 shows a flowchart 300 that illustrates a method for updating a safety program according to an embodiment. The safety program can be configured to be executed in a safety apparatus in order to control a sensor of an industrial system and/or an actuator of the industrial system. In 302, update information is obtained. In 304, the update information is evaluated. In 306, it is determined whether the update information can be applied to the safety program. Then, based on the determination 306, the update information is either applied to the safety program in 308 or the update information is discarded in 310.

### REFERENCE NUMERAL LIST

100 production environment
102 version control system
104 software version catalog
106 update dispatcher
108i update agent
110i automated resource orchestrator
112i, robot or machine
200 industrial system
202 sensor
204 actuator
206 safety apparatus
208 update device
300 flowchart that illustrates a method for updating a safety program according to an embodiment
302 step of obtaining update information
304 step of evaluating the update information
306 step of determining whether the update information can be applied to the safety program
308 step of applying the update information to the safety program
310 step of discarding the update information

1. An industrial system, comprising:
a sensor and/or an actuator;
a safety apparatus configured to execute a safety program for controlling
the sensor and/or the actuator; and
an update device configured:
to obtain update information;
to evaluate the update information;
based on the evaluation, to determine whether the update information can be applied to the safety program; and,
based on the determination, either to apply the update information to the safety program or to discard the update information.

2. The industrial system according to claim 1,
wherein the evaluation of the update information comprises applying the update information to a second safety program.

3. The industrial system according to claim 2,
wherein the application of the update information to the safety program comprises using the second safety program as the safety program.

4. The industrial system according to claim 1,
wherein the evaluation of the update information comprises an automated acceptance test.

5. The industrial system according to claim 1,
wherein the evaluation of the update information comprises checking whether all the parts of the safety program to be updated are covered by the update information.

6. The industrial system according to claim 1,
wherein the evaluation of the update information comprises checking whether the update information does not include a contradiction.

7. The industrial system according to claim 1,
wherein the evaluation of the update information comprises checking whether the update information does not include different version numbers.

8. The industrial system according to claim 1,
wherein the evaluation of the update information is based on a digital signature of artifacts that are described in the update information.

9. The industrial system according to claim 1,
wherein the evaluation of the update information is based on a checksum.

10. The industrial system according to claim 1,
wherein the update device is further configured to determine whether a safety system, which is monitored by the safety program, is in a predefined state;
wherein the evaluation of the update information and/or the application of the update information to the safety program is/are only performed if it is determined that the safety system is in a predefined state.

11. The industrial system according to claim 10,
wherein the predefined state has a pause state or a predefined safe state.

12. The industrial system according to claim 1,
wherein the update information comprises information for an update of the safety program and/or a troubleshooting for the safety program and/or a new functionality for the safety program.

13. The industrial system according to claim 1,
wherein the actuator comprises a robot and/or a machine.

14. The industrial system according to claim 1,
wherein the sensor is configured to acquire measurement data with respect to a human in an environment of the actuator.

15. A method for updating a safety program, wherein the safety program is configured to be executed in a safety apparatus in order to control a sensor of an industrial system and/or an actuator of the industrial system, the method comprising:
obtaining update information;
evaluating the update information;
based on the evaluation, determining whether the update information can be applied to the safety program; and
based on the determination, either applying the update information to the safety program or discarding the update information.

16. A computer readable storage medium comprising commands that, on the execution by a computer, cause it to carry out the method according to claim 15.
